(19) United States
(12) Patent Application Publication
(10) Pub. No.: US 2026/0209531 A1
(43) Pub. Date: Jul. 23, 2026

(54) METAL EFFECT PIGMENT-FREE RADAR-COMPATIBLE COATING ON A SUBSTRATE

(71) Applicant: Merck Patent GmbH, Darmstadt (DE)

(72) Inventors: Udo GUMSHEIMER, Darmstadt (DE); Kevin KAISER, Darmstadt (DE)

(73) Assignee: Merck Patent GmbH, Darmstadt (DE)

(21) Appl. No.: 19/561,996

(22) Filed: Mar. 10, 2026

Related U.S. Application Data
(62) Division of application No. 18/027,995, filed on Sep. 27, 2021.

(30) Foreign Application Priority Data
Sep. 28, 2020 (EP) 20198643.7

(51) Int. Cl. C09D 7/40; C09D 1/00

(52) U.S. Cl. CPC C09D 7/70; C09D 1/00

(57) ABSTRACT

The present invention relates to a metal effect pigment-free radar-compatible coating on a substrate, to a process for the production of such a coating, and to the use of such a coating, in particular in vehicle construction.

The present invention relates to a metal effect pigment-free radar-compatible coating having a metallic character on a substrate, to a process for the production of such a coating on a substrate, and to the use of such a coating, in particular in vehicle construction.

With the increase in vehicles that enable autonomous driving, it is necessary to integrate radar devices which enable both distance measurement to other vehicles or traffic obstacles and the measurement of the speed of other traffic participants into the corresponding automobile parts to a hitherto unimagined extent. Such radar devices are generally installed behind bumpers of vehicles in order not to adversely impair the visual appearance of the vehicle.

For many years, metallic paints, preferably silver-coloured metallic paints, have counted amongst the most popular vehicle paints, in particular for the private vehicle sector. However, these metallic paints represent a major challenge in relation to the optical design of cover parts for radar devices installed in the interior of such vehicles since the usual metallic paints, which contain aluminium-based metal-effect pigments, can reflect, attenuate or absorb the radar waves, which are usually in the frequency range 76-81 GHz, to such an extent that the use of previously customary metallic vehicle paints for cover parts of radar devices in vehicles would lead to an undesired reduction in the functionality of the radar devices.

There has therefore been no lack of attempts to provide solutions for the covering of vehicle radar devices that do not impair the visual appearance of the vehicles and enable good functionality of the installed radar devices.

Corresponding cover parts, which are designed, for example, as radiator grilles or company logos and have very substantially radar wave-transparent areas and metallised struts, often have layers of vapour-deposited metals, such as indium. Such components usually exhibit a chrome-like visual appearance.

However, coatings of this type are not suitable for vehicle parts which, although located in the beam path of a radar device, are intended to leave the observer with the visual impression of a conventional silver-coloured metallic paint. The difficulty here consists in achieving the strong lightness flop that is usual in the case of metallic paints containing metal pigments (clear change from light to dark on a change in the illumination or viewing angle), achieving the hiding power of metallic paints of this type, and reducing the attenuation of radar waves to such an extent that the transmission of the radar waves is sufficient to be able to operate an installed radar device in a fully functional manner.

JP 2004-244516 A discloses a lustrous product having high transparency for electromagnetic radiation which can be employed as radiator grille, but also as component of another vehicle part, for example of a tailgate. A layer on a polycarbonate panel here may comprise metal particles, such as zinc, tin or indium, but may instead also be pigmented with interference pigments, such as, for example, titanium dioxide-coated mica. The particles are applied to the panel in a concentration of 3 to 8% by weight in a polyurethane-containing layer. A black base coat is applied thereto as reverse-side coating.

The lustrous product obtained comprising a plurality of layers is claimed to have high transparency for electromagnetic radiation and high lustre.

Although good transparency for radar waves can be achieved with interference pigments comprising titanium dioxide-coated mica in such coatings, the hiding power of metallic finishes containing metal pigments and the strong metallic lightness flop that can be achieved with the latter is, however, not obtainable just with transparent and colourless mica-based interference pigments of this type having a simple structure.

JP 2006-282886 A also discloses a radar wave-transparent coating for a vehicle part which comprises interference pigments in a layer on a plastic substrate and omits metal-effect pigments. In order to enable colour variance of the coating, the interference pigments are said to be based on particularly smooth substrate particles. Silicon dioxide or aluminium oxide substrate flakes are proposed as suitable substrate flakes. However, the visual impression of a metallic finish can likewise not be achieved with a layer of this type comprising interference pigments on a plastic substrate to be coated.

The object of the present invention consists in providing a radar wave-transparent coating on a substrate, which coating is suitable for use for cover parts of radar devices, in particular in vehicle construction, and omits conventional metal-effect pigments, in particular aluminium pigments, preferably differs as little as possible visually from conventional silver-coloured vehicle metallic finishes and in particular has a silver-coloured metallic appearance, high hiding power and a strong lightness flop at the same time as good transparency for radar waves.

A further object of the present invention consists in providing a process for the production of the above-mentioned coating.

In addition, a further object of the present invention consists in indicating the use of such a coating on a substrate.

The object of the present invention is achieved by a radar-compatible coating comprising flake-form effect pigments on a substrate, where the coating is free from metal-effect pigments and has at least two layers, in this sequence, on the substrate:
A)—a first layer, which represents a base layer, comprises absorbent pigments and is free from flake-form effect pigments, and
B)—a second layer, which is applied to the first layer and comprises flake-form effect pigments having absorbent properties in an amount of at least 10% by weight, based on the weight of the second layer,
   and where the second layer, when it is applied over the full area of a black/white background in a layer thickness of 14±2 μm and is measured spectrophotometrically in the L*,a*,b* colour space at an illumination angle of 45° and at a viewing angle of 75°, has a colour separation ΔE* between the coated black background and the coated white background in the range from 0 to 20.

In addition, the object of the present invention is also achieved by a process for the production of such a metal effect pigment-free radar-compatible coating comprising flake-form effect pigments on a substrate, in which
a first layer which comprises at least one absorbent pigment and is free from flake-form effect pigments is applied as base layer to an optionally precoated substrate comprising a plastic plate or plastic film, and subsequently
a second layer which comprises flake-form effect pigments having absorbent properties is applied to the first layer in an amount of at least 10% by weight, based on the weight of the solid layer,
   where the second layer is applied as a single layer or in two or more part-layers arranged one above the other and drying is carried out after application of each layer.

In addition, the object of the invention is also achieved by the use of a coating as described above on a substrate as radar-compatible vehicle finish on a vehicle part.

The present inventors have surprisingly found that it is possible to provide cover parts of radar devices in vehicle construction with coatings which have a layer comprising flake-form effect pigments, where the coating as a whole is free from metal-effect pigments, but has visually a silver-coloured metallic character.

Although flake-form effect pigments which do not have any metal layers generally do not lead to strong attenuation of the radar signal in coatings, they usually exhibit little or no inherent absorption and only low hiding power. These properties have the effect that an opaque, silver-coloured coating having high lustre and a strong lightness flop, as is characteristic of metallic finishes, cannot be achieved with the conventional flake-form effect pigments, which are usually interference pigments. The aim was therefore to find out the conditions under which coatings which meet the requirements of hiding power, lightness flop and radar compatibility can be obtained on cover parts for radar devices in vehicle production without metal-effect pigments being present in the coating, but the visual appearance of a metallic finish can be imitated to an adequate extent.

The present inventors have found a layer structure on a substrate which satisfies the said conditions well.

The layer structure according to the invention accordingly consists at least of a layer system comprising two successive layers on a substrate, where the first layer, which is located directly on the substrate or alternatively also on a precoated substrate, in particular on a substrate precoated with a primer layer, comprises absorbent pigments and has an achromatic chromaticity.

In general, white, grey or black are not referred to as colours in expert circles since they are achromatic optical phenomena which merely denote the amount of light absorbed by the respective surface. In the present invention, by contrast, white, grey and black will, however, be regarded as colours.

The first layer of the coating according to the invention comprises no flake-form effect pigments, i.e. neither metal-effect pigments nor other flake-form effect pigments, such as, for example, interference pigments.

Accordingly, the first layer has a solid, effect-free, neutral coloration. It completely hides the substrate or, if present, the precoating on the substrate.

Suitable absorbent pigments for the first layer are organic or inorganic pigments having absorbent properties. These are essentially the classical organic absorption pigments or inorganic absorbent pigments All absorption pigments that are usually employed in various industrial coatings can be used for this purpose. These are preferably available with a particle diameter in the range from 10 to 500 nm, in particular from 10 to <100 nm. Preparations of absorption pigments are generally commercially available. Depending on compatibility with the paint systems employed, systems such as, for example, Heucotint® W (Heubach, DE), Heucotint® UN (Heubach, DE), MIPA WBC (Mipa, DE), Standoblue® (Standox GmbH, DE), Standohyd® (Standox GmbH, DE), Vocaflex® (Arichemie, DE), Vocaplast® (Arichemie, DE), or also others come into consideration.

Suitable absorption pigments are, for example, isoindolidones, benzimidazoles, quinacridones, Cu phthalocyanines, perylenes, carbon black and/or titanium dioxide, to mention just a few. Coloured absorption pigments can be employed in suitable mixtures in order to obtain a neutral, achromatic colouration of the first layer.

The absorbent pigments are present in the first layer in an amount of 1 to 50% by weight, preferably in the range from 20 to 40% by weight, based on the weight of the first layer. They can be employed individually or in a mixture of two or more. Mixtures are preferably employed, in particular in the case of the grey shades. The figures relate to the weight of the solid layer.

The layer thickness of the first layer is not crucial for the success of the present invention. A layer thickness is set that completely hides the substrate or any precoating located on the substrate and is economically reasonable. Usual layer thicknesses of the first layer are in the range from 5 to 15 μm, but may also deviate therefrom if required.

In accordance with the invention, the layer thickness of the first layer and the concentration of the absorbent pigments in the first layer are set within the above-mentioned limits so that the first layer, when it is applied as a single layer to the full area of a standardised black/white background and is measured spectrophotometrically in the L*,a*,b* colour space at an illumination angle of 45° and at a viewing angle of 75°, has a colour separation ΔE* between the coated black background and the coated white background in the range from 0 to 5, preferably from 0 to <2 and in particular from 0 to <1.

The first layer represents the base layer of the coating according to the invention on the substrate.

In accordance with the invention, a second layer is arranged directly on the first layer. The second layer is pigmented with flake-form effect pigments, but comprises no metal-effect pigments and also no other metal pigments. In accordance with the invention, the flake-form effect pigments in the second layer have absorbent properties. They are preferably flake-form interference pigments which have a silver-grey absorption colour.

The optical effect of flake-form interference pigments generally consists of a combination of reflection and transmission phenomena of light at a sequence of thin layers of which effect pigments of this type, usually on a flake-form support material, generally consist. Use is very frequently made here only of materials which are colourless and are very substantially transparent to visible light, such as, for example, flake-form mica pigments coated with titanium dioxide. Such pigments can have a silvery interference colour or also chromatic interference colours, but overall are transparent and have no mass tone.

Interference pigments achieve absorbent properties and thus a mass tone if either the flake-form support or alternatively at least one of the layers located on the flake-form support consists of a material which has an inherent colour, i.e. an absorption colour. These can be coloured metal oxides, metal suboxides, mixed metal oxides or oxygen-deficient metal oxides or metal oxide hydrates. Interference pigments also achieve absorbent properties due to layers which comprise organic coloured pigments.

In the present invention, interference pigments, which have at least one layer comprising an iron oxide, a mixed oxide comprising iron oxide and titanium oxide, or a titanium suboxide, or have a layer consisting of carbon, are preferably employed in the second layer. One or more other layers comprising colourless, transparent materials may additionally be located on the flake-form support material.

Iron oxides which come into consideration are Fe₂O₃, FeO, Fe₃O₄ or FeOOH. Mixed oxides of iron oxide and titanium oxide are frequently ilmenite (FeTiO₃) or pseudobrookite (Fe₂TiO₅). Suitable titanium suboxides are TiO, Ti₂O₃, Ti₃O₅, Ti₄O₇, Ti₂O, Ti₃O or Ti₆O.

The layer thicknesses of the absorbent layers comprising an iron oxide, a mixed oxide comprising iron oxide and titanium oxide, or a titanium suboxide, or the layer consisting of carbon, are set so that the interference pigment has a silver-grey absorption colour. By contrast, all other layers optionally present on the support material do not make a contribution to the absorption colour.

Suitable further colourless transparent layers on the flake-form support material are, in particular, layers comprising colourless metal oxides or metal oxide hydrates, such as tin oxide, titanium dioxide, zirconium oxide, silicon dioxide, silicon oxide hydrate, aluminium oxide or aluminium oxide hydrate.

Flake-form support materials which come into consideration are natural or synthetic mica, kaolin, talc or sericite, in addition also glass, calcium aluminium borosilicate, SiO₂, TiO₂ or Al₂O₃. The flake-form support materials employed are preferably natural or synthetic mica or Al₂O₃ flakes.

Interference pigments of the said type are commercially available. They are available, for example, from Merck KGaA under the trade names Iriodin® 9602 Silver-Grey SW or Iriodin® 9605 Blue Shade Silver SW. These are based on mica flakes and have at least one layer which comprises an iron oxide or a titanium suboxide.

It is particularly preferably also possible to employ interference pigments which have one or more interference layers and, as the final layer, a very thin, light-transmitting layer consisting of carbon on a transparent support flake. Such pigments have been described, for example, in the patent application EP 3795645 A1 by the present patent applicant.

It has been found that interference pigments having a silver-grey absorption colour are particularly suitable for use as effect pigments having absorbent properties in the second layer since the coating as a whole is intended to have a silver-metallic appearance. Due to the pigment structure in the form of sequences of thin layers on flake-form substrates, interference pigments of this type exhibit a visually perceptible lustre when incident light hits them. The silver-grey absorption colour causes adequately high lightness in the case of direct incidence of light.

These interference pigments having absorbent properties generally have particle sizes in the range from 1 to 100 μm, in particular from 2 to 70 μm and particularly preferably in the range from 3 to 50 μm. The thickness of the interference pigments is in the range from 0.1 to 2 μm.

The particle size of the effect pigments having absorbent properties can be determined by means of laser diffractometry. The particle size and the particle size distribution in relation to volume is preferably determined using a Malvern instrument (Malvern Mastersizer 3000, APA300, product from Malvern Instruments Ltd., UK) in standard mode.

However, usual particle size ratios can also be found in the manufacturer's data in publicly accessible product information sheets.

In this size range, adequate hiding power in the overall structure can be obtained if the amount of the effect pigments having absorbent properties and the layer thickness of the second layer are set in accordance with the invention.

In accordance with the invention, the minimum amount of flake-form effect pigments having absorbent properties in the second layer is 10% by weight, based on the weight of the (solid) second layer. The maximum amount of flake-form effect pigments having absorbent properties in the second layer is 40% by weight, based on the weight of the second layer. These effect pigments are preferably employed in the second layer in a concentration of 15 to 35% by weight, based on their weight, in the second layer.

In accordance with the invention, the layer thickness of the second layer is in the range from 3 to 25 μm, preferably in the range from 5 to 20 μm.

If it appears advantageous, the second layer may also comprise one or more of the absorption pigments described above for the first layer, so long as the optical measurement values for the hiding power (ΔE*), the lightness (L*15) and the lightness flop (flop index) thereby remain in the specified limits.

The overall optical effect from opaque, achromatic first layer and second layer which comprises interference pigments having a silver-grey absorption colour gives rise to a homogeneous silver-metallic overall impression of the coating according to the invention having high hiding power, high lustre and clear lightness flop.

The hiding power here is determined from the ΔE* values, which can be determined on spectrophotometric measurement of coated substrates in the L*,a*,b* colour space. The quantity ΔE* is defined here as the colour separation of samples in the L*a*b* colour space over a standardised black and white background at an illumination angle of 45° and a viewing angle of 75°

$$Δ {E}^{*} = √ ( Δ {L}^{* 2} + Δ {a}^{* 2} + Δ {b}^{* 2} ) .$$

The lower the value for the colour separation turns out, the better the coating hides the background. Complete hiding of the background generally cannot be achieved with non-metallic effect pigments. The second layer employed in the coating according to the invention has a ΔE* value in the range from 0 to 20, preferably in the range from 5 to 20, if the second layer is applied to the black/white background in a layer thickness in the range 14±2 μm and is measured under the above-mentioned measurement conditions. These values indicate a hiding power of the second layer that is sufficient for the purposes of the present invention.

A measure used in expert circles for the lightness of a layer is the L*15 value of a coating, which is determined photometrically in the L*,a*,b* colour space on a standardised black/white background at an illumination angle of 45°. In order to be suitable as coating according to the invention, this should have a minimum lightness, which is obtained both over a white base layer and also over a black base layer.

On use of the above-mentioned effect pigments having a silver-grey absorption colour in the second layer, a second layer is obtained which, when it is applied to the full area of a black/white background in a layer thickness of 14±2 μm and is measured spectrophotometrically in the L*,a*,b* colour space at an illumination angle of 45° and at a viewing angle of 15°, has a lightness L*15 of at least 105 both on the coated white background and on the coated black background.

In addition, a good lightness flop can also be achieved. As standard, this is quoted as the flop index and is determined spectrophotometrically at an illumination angle of 45° and at an aspecular separation of 15°, 45° and 110° from the specular angle. In accordance with the invention, the flop index is therefore in the region of at least 10 both on a white-coated background and on a black-coated background if the second layer, when it is applied to the full area of a black/white background in a layer thickness of 14±2 μm and is measured spectrophotometrically in the L*,a*,b* colour space at an illumination angle of 45° and at viewing angles of 45°: as 15°, 45°: as 45° and 45°: as 110°.

The flop index is usually regarded in the art as a measure of the lightness flop at varying viewing angles and is determined in accordance with the formula:

$$0.86 \text{?} ndex Flop Index = \frac{2.69 {( {L}_{15 °}^{*} - {L}_{110 °}^{*} )}^{1.11}}{{( {L}_{45 °}^{*} )}^{0.86}}$$

$$\text{?} \text{indicates text missing or illegible when filed}$$

The quoting of upper limit values is not appropriate either for the lightness L*15 or for the flop index since both quantities have open upper limits and measurement results that are above the stated minimum values in each case have a positive effect on the overall optical result on observance of a hiding power in the stated range.

Details on the spectrophotometric measurement methods and instruments are described in the example part.

Surprisingly, it has been found that, in particular, the lightness flop of the coating according to the invention, quoted through the flop index, can in some cases be significantly improved, especially on a grey or black first base coat on a substrate, if the second layer consists of two or more, preferably of three or four, part-layers arranged one above the other, without significant impairment of the hiding power or the lightness of the coating as a whole having to be accepted. The total dry-layer thickness of the second layer in these cases is preferably merely in the range from 5 to 15 μm.

At least one of the part-layers, preferably two or three of the part-layers, has a dry-layer thickness of ≤5 μm. In particular, the dry-layer thickness of at least one of the part-layers is ≤4 μm or ≤3 μm, particularly preferably about 2 μm. These extremely low layer thicknesses can preferably also be present in two or three of the part-layers.

In order to be able to combine such thin part-layers to give a visually attractive overall layer as second layer of the coating according to the invention, smooth surfaces of the individual part-layers are necessary. These arise from interfaces between the individual part-layers of the second layer that are arranged substantially parallel to the base layer or to the coated substrate. The interfaces are obtained by interim drying after application of each of the individual part-layers. Due to the interim drying, the flake-form effect pigments having absorbent properties in each of the part-layers are aligned with their principal axes approximately parallel to the surface of the first layer (and of the substrate) and thus achieve good reflection of the incident light in each individual part-layer.

The pigment loading of the individual part-layers is likewise at least 10% by weight of flake-form effect pigments having absorbent properties and is a maximum of 40% by weight, in each case based on the weight of the individual part-layer. 15 to 35% by weight of flake-form effect pigments having absorbent properties are preferably employed in each of the part-layers.

“Radar-compatible” in the sense of the present invention is taken to mean a coating which has a permittivity of <30 on exposure to electromagnetic waves having a peak frequency of 76.5 GHz. Furthermore, it is necessary for the coating on a 350 μm PET substrate to have one-way transmission attenuation of <2 dB on exposure to electromagnetic waves having a peak frequency of 76.5 GHz.

The measurement of the permittivity of the coating and the one-way transmission attenuation of the coating on the substrate is carried out using an RMSD-77/79G instrument from perisens GmbH, Germany, in standard mode.

The binders employed for the first and second layers of the coating according to the invention can be all conventional binders and binder systems that appear transparent in the solidified state. Recourse can be made here to all common types of binder that are employed in conventional coating processes and are compatible with the pigments employed. Solvent-based binder systems, aqueous binder systems and radiation-curing binder systems can be employed equally, so long as peculiarities that are usual in the art regarding the choice of pigment and regarding the coating process are observed.

Both the first and second layers of the coating according to the invention may comprise further additives that are usual in the art, such as, for example, fillers, inhibitors, flameproofing agents, lubricants, rheology aids, dispersants, redispersants, antifoams, flow-control agents, film formers, adhesion promoters, drying accelerators, photoinitiators, etc.

If the second layer consists of two or more part-layers, the use of rheology aids is generally indicated. Rheology aids which come into consideration are substances such as, for example, BaSO₄, polyamide powder, silicates or other rheology aids that are familiar to the person skilled in the art, but in particular cellulose-based nanofibres. The latter are particularly preferably employed.

Depending on the binder system employed, the coating compositions employed for the production of the first and second layers of the coating optionally also comprise organic solvents and/or water, which, however, are no longer present in the coating according to the invention after solidification of the two layers. The solvent systems that are usual in the art can be employed without restrictions. Corresponding compositions for binder systems, including solvents and additives, are adequately known to the person skilled in the art and in some cases are also commercially available in the unpigmented state as finished products. A corresponding selection can be made by the person skilled in the art on the basis of the respective pigmentation to be employed and the desired coating process.

Possible substrates to which the coating according to the invention comprising the first and second layers is applied are plastic plates or films if the coating is intended to be radar-compatible. The plastics usually used in automobile construction can be used, for example polycarbonate (PC), polypropylene (PP), polyurethane (PUR), polymethyl methacrylate (PMMA), acrylonitrile-butadiene-styrene (ABS) or acrylonitrile-ethylene-styrene (AES) substrates, to mention just a few. Plastic plates or plastic films of this type have a certain base attenuation of the radar signal, which should experience only a slight increase due to the coating located thereon. In respect of the radar capability of the coating according to the invention, the value of the base attenuation of the radar signal with respect to one-way transmission, which is present due to the respective substrate, is included in the measurement values. The base attenuation of the one-way transmission of the radar signal that is caused solely by the substrate is indicated separately in Example 4. Measurement of the radar signal attenuation caused solely by the coating is not possible for technical equipment-related reasons.

If the coating according to the invention is intended to be applied to substrates for purely optical reasons and if the focus is not on the radar compatibility of the coating, it is of course also possible to employ metallic or metal-containing substrates.

It goes without saying that the substrates can be three-dimensionally shaped, i.e. can have a three-dimensional outer shape, depending on the application. Thus, example, a plastic plate which is intended to form part of a vehicle tailgate naturally has a different three-dimensional outer shape than a plastic plate intended as bumper. In general, the three-dimensional shape of the substrate is produced by means of conventional shaping processes before application of the coating according to the invention.

An essential core element of the coating according to the invention on a substrate is the package comprising the first and second layers described above, where the second layer is arranged directly on the first layer, viewed from the substrate. In addition, further layers, which may likewise be part of the coating according to the invention, may optionally also be located between the substrate and the first layer and/or above the second layer.

Additional layers of this type are frequently employed in automobile construction in order either to improve the adhesion of the paint layers to the substrate and/or to improve the mechanical and chemical strength and the weathering resistance of the paint layers. These are primer layers or an outermost clear coat, which is generally designed to be transparent and colourless. The coating in accordance with the present invention can advantageously have a primer layer and/or a clear coat. In accordance with the invention, all conventional materials which are widely used industrially and therefore do not require further explanation can be employed here.

The coating according to the invention on a substrate can advantageously be employed in all cases where radar devices are to be provided with covers which visually have a silver-coloured effect finish without the functionality of the radar devices being adversely affected. This naturally applies, in particular, to cover parts used in vehicle construction. The coating according to the invention is preferably a vehicle finish. Owing to its good optical properties, this can of course also be used for finishes of all types that are intended to correspond visually very substantially to a conventional silver-coloured metallic finish. The radar wave transparency present may also play a subordinate role and the corresponding areas of use are not restricted to vehicle construction.

The present invention also relates to a process for the production of a metal effect pigment-free radar-compatible coating comprising flake-form effect pigments on a substrate, as described above, in which a first layer which comprises at least one absorbent pigment and is free from flake-form effect pigments is applied as base layer to an optionally precoated substrate comprising a plastic plate or plastic film, and a second layer which comprises flake-form effect pigments having absorbent properties in an amount of at least 10% by weight, based on the weight of the solid layer, is subsequently applied to the first layer, where the second layer is applied as a single layer or in two or more part-layers arranged one above the other and drying is carried out after application of each layer.

All material details in relation to the suitable plastic substrates and the compositions of the first and second layers have already been explained above. To this extent, reference is made thereto here.

The two layers of the coating can be applied to the substrate by means of conventional coating processes, for example by spray processes, brushing processes, in-mould processes, roller coating processes, coil coating processes or curtain coating processes.

Coating processes of this type are usual in large-scale industry and can be employed in accordance with the art.

Spray processes are preferably employed.

Conventional spray technologies, in which dry-layer thicknesses in the range from 5 to 25 μm can be obtained with a single spray operation, are suitable for the production of the coating according to the invention. For the production of the coating according to the invention comprising first and second layers, two coating operations are sufficient here, where the second layer is applied immediately after application of the first layer, with or without interim drying, the layer(s) are dried and the two layers are hardened in combination.

For the application of the second layer, however, particularly suitable spray processes are those which allow part-layers arranged one on top of the other to be applied successively in a plurality of working steps to the first layer of the coating according to the invention with very low dry-layer thickness of the individual part-layers. The preferably two to four part-layers are in each case dried after application of each individual part-layer, so that interfaces form between the individual part-layers. The temperature for the drying of the individual layers is dependent on the respective binder system and the solvents employed and is at least 20° C. Temperatures up to 150° C., preferably up to 100° C., can be employed.

The amount of flake-form effect pigments having absorbent properties in the second layer is at least 10% by weight, based on the weight of the dry layer, for each of the individual part-layers, but can be in the range from 10 to 40% by weight, in particular in the range from 15 to 35% by weight. The dry-layer thickness of at least one of the part-layers is ≤5 μm, preferably ≤4 μm and in particular ≤3 μm or about 2 μm. Preferably, two or three part-layers have such low layer thicknesses.

The high pigment concentration in the respective part-layers in the case of a very low dry-layer thickness of the part-layers can be set by very greatly reducing the proportion of binders in the respective coating composition (solids content about 6 to 7% by weight) and very greatly increasing the proportion of solvents (preferably water). In order that a very dilute coating composition of this type can form a continuous coating film on the substrate, various assistants, in particular rheology aids, are added which ensure that a suitable viscosity of the coating composition is set, so that this can be applied to the background by means of a spray process and exhibits good flow properties. In the course of the subsequent drying process, a small solid mass having a very high proportion of effect pigments remains on the respective background as part-layer, in which the effect pigments are also aligned well with their principal axes essentially parallel to the respective coated surface.

In accordance with the invention, the rheology aids added here are preferably cellulose-based nanofibres in an amount of 5 to 20% by weight, based on the weight of the coating composition.

Due to the multiple application of part-layers arranged one above the other and the respective interim drying of the part-layers, the flake-form effect pigments in the second layer can be oriented particularly well so that high reflection of incident light at the surface of the second layer is obtained. This improves, in particular, the lightness flop of the coating as a whole at the same time as overall an extremely low total layer thickness of the second layer, without significant impairment of the hiding power or lightness of the layer structure as a whole. A particularly preferred embodiment of the coating according to the invention which very substantially corresponds visually to a silver-coloured metallic finish, but has good radar compatibility if it is applied to a plastic substrate, can thus be achieved on a substrate with flake-form effect pigments having absorbent properties in the second layer and without the use of metal pigments of all types in the coating as a whole.

The plastic substrates employed, which have predefined radar properties, can optionally be precoated, for example with one or more primer and/or colouring layers. If, however, the coating as a whole is to have a radar-compatible character, it must be ensured that none of the layers optionally additionally present on the respective substrate comprises metal-effect pigments or other constituents which could adversely affect the requisite radar wave transparency of the coating as a whole.

Precoating of the plastic substrate with a primer layer is advantageous since such primer layers improve, inter alia, the mechanical stability of the coating as a whole and the adhesion of the first layer of the layer package to the substrate. In addition, outermost clear coats, which are generally designed to be colourless and transparent to visible light, are advantageous, in particular for the mechanical stability and the weathering resistance of coatings. In the present invention, they are also preferably applied to the upper layer of the layer package comprising first and second layers as outermost layer of the coating as a whole.

It goes without saying that the coating as a whole is subjected to at least one hardening operation, which is carried out either after application and drying of the second layer on the substrate and/or after application of the clear coat. The hardening of coatings on substrates, in particular in the automobile sector, is a standard activity in the art and need not be described in greater detail.

The present invention also relates to the use of the metal effect pigment-free coating described above as radar-compatible vehicle finish on a vehicle part. It can be applied to all vehicle parts based on plastic base bodies (substrates). Metal substrates are not suitable since they cannot guarantee the desired radar capability. The coating can be applied to external bodywork parts which are intended as outer cover or screening parts for radar devices installed in the vehicle interior, or can also be applied to the entire surface of suitable bodywork parts. Bodywork parts which may be mentioned are, in particular, bumpers, tailgates, radiator grilles, wings or parts thereof. The coating according to the invention can of course also be applied to vehicle parts other than those mentioned and in particular also to metal-containing substrates if only the visual appearance of a metallic finish is of interest and the radar capability is not necessary. In the latter case, the area of application of the invention is also not restricted to vehicle construction.

The invention is intended to be explained below with reference to examples, but not restricted thereto.

### EXAMPLES

Black/white-coated Leneta panels (white and black base layer already present on the respective part-area) as substrate are coated with a second layer. The coating is carried out as pneumatic spray coating. The binder employed is the preparation WBC 000 from MIPA SE, DE. Finally, all samples are coated with a standard 2-component clear coat.

The second layer is pigmented with interference pigments having a silver-grey absorption colour in the amounts indicated in the tables.
Effect pigment A: interference pigment based on mica with coating comprising SnO₂, TiO₂ and carbon (C content 1.14%), particle size 5-25 μm;
Effect pigment B: interference pigment based on aluminium oxide flakes with coating comprising SnO₂, TiO₂ and carbon (C content 0.44%), particle size 5-30 μm;
Effect pigment C: interference pigment based on mica with coating comprising SnO₂, TiO₂, titanium suboxide and assistants, particle size 5-40 μm

### Example 1

In order to determine the hiding power of the coatings according to the invention, coating compositions comprising pigments A, B and C with a pigment mass concentration of 18% by weight, based on the weight of the solid second layer, are applied to the standardised black-and-white-coated panels in a single coating operation and dried at 80° C. for 5 minutes. The smaller the colour separation ΔE* 75° comes out, the better the hiding power of the effect pigment.

If the second layer is applied in four part-layers (in each case 18% by weight PMC, layer thicknesses 9, 2, 2, 2 μm, drying in each case for 5 min. at 80° C.), only slight changes in the hiding power arise compared with the single-layer process.

TABLE 1
Hiding power

| Pigment | Part-layers | PMC (%) | DLT (μm) | ΔE* 75° |
|---|---|---|---|---|
| A | 1 | 18 | 15 | 7 |
| B | 1 | 18 | 15 | 20 |
| C | 1 | 18 | 15 | 18 |
| A | 4 | 18 | 15 | 9 |
| B | 4 | 18 | 15 | 25 |
| C | 4 | 18 | 15 | 20 |

Part-layers: number of part-layers of the second layer of the coating
PMC: pigment mass concentration of effect pigments in each of the part-layers
DLT: dry-layer thickness of the entire second layer, consisting of x part-layers
L*: lightness value L* in the L*a*b* colour space at a viewing angle of 15°, illumination angle 45°)
ΔE*: colour separation of samples in the L*a*b* colour space over standardised black and white background (illumination angle 45°, viewing angle 75°), determined in accordance with the formula:

$$Δ {E}^{*} = √ ( Δ {L}^{* 2} + Δ {a}^{* 2} + Δ {b}^{* 2} )$$

Flop index: measure of the lightness flop at varying viewing angles (illumination angle 45°, viewing angles 45°: as 15°, 45°: as 45°, 45°: as 110°), determined in accordance with the formula:

$$0.86 \text{?} ndex Flop Index = \frac{2.69 {( {L}_{15 °}^{*} - {L}_{110 °}^{*} )}^{1.11}}{{( {L}_{45 °}^{*} )}^{0.86}}$$

$$\text{?} \text{indicates text missing or illegible when filed}$$

### Basis: Colour Shade of the First Layer

### Example 2

In order to determine the lightness of the respective coating, effect pigments A, B and C as in Example 1 are applied to the respective black or white background. In addition, the same pigments are applied to the black- or white-coated background in a three-step process in a layer thickness of about 2 μm per part-layer (drying after each application: 80° C., 5 min.) with a pigment mass concentration of 30% by weight in each case, based on the weight of each part-layer. The greater the lightness values L*15 come out, the better a coating pigmented opaquely merely with aluminium pigments can be imitated visually.

TABLE 2
Lightness

| Pigment | Part-layers | PMC (%) | DLT (μm) | L* 15 | Basis |
|---|---|---|---|---|---|
| A | 1 | 18 | 15 | 110 | White |
| B | 1 | 18 | 15 | 120 | White |
| C | 1 | 18 | 15 | 119 | White |
| A | 1 | 18 | 15 | 110 | Black |
| B | 1 | 18 | 15 | 120 | Black |
| C | 1 | 18 | 15 | 119 | Black |
| A | 4 | 18 | 15 | 118 | White |
| B | 4 | 18 | 15 | 120 | White |
| C | 4 | 18 | 15 | 120 | White |
| A | 4 | 18 | 15 | 117 | Black |
| B | 4 | 18 | 15 | 119 | Black |
| C | 4 | 18 | 15 | 120 | Black |
| A | 3 | 30 | 6 | 118 | White |
| B | 3 | 30 | 6 | 120 | White |
| C | 3 | 30 | 6 | 120 | White |
| A | 3 | 30 | 6 | 118 | Black |
| B | 3 | 30 | 6 | 120 | Black |
| C | 3 | 30 | 6 | 120 | Black |

High lightness values can be obtained with each of the coating variants and each of the effect pigments in the second layer.

### Example 3

In order to determine the flop index, all coatings produced in Example 2 are re-measured.

TABLE 3
Flop index

| Pigment | Part-layers | PMC (%) | DLT (μm) | Flop index | Basis |
|---|---|---|---|---|---|
| A | 1 | 18 | 15 | 12 | White |
| B | 1 | 18 | 15 | 13 | White |
| C | 1 | 18 | 15 | 14 | White |
| A | 1 | 18 | 15 | 13 | Black |
| B | 1 | 18 | 15 | 20 | Black |
| C | 1 | 18 | 15 | 20 | Black |
| A | 4 | 18 | 15 | 15 | White |
| B | 4 | 18 | 15 | 13 | White |
| C | 4 | 18 | 15 | 15 | White |
| A | 4 | 18 | 15 | 17 | Black |
| B | 4 | 18 | 15 | 26 | Black |
| C | 4 | 18 | 15 | 23 | Black |
| A | 3 | 30 | 6 | 14 | White |
| B | 3 | 30 | 6 | 12 | White |
| C | 3 | 30 | 6 | 14 | White |
| A | 3 | 30 | 6 | 18 | Black |
| B | 3 | 30 | 6 | 28 | Black |
| C | 3 | 30 | 6 | 26 | Black |

Conventional silver-metallic coatings, which generally comprise aluminium pigments, have flop indices in the range from about 12 to 17.

This range can be achieved by all said coating variants and all said silver-grey interference pigments. In particular, the multilayered coating variants on a black background achieve very high values for the flop index.

The colorimetric measurement of the samples is carried out using a model BYKMac i colorimeter (Byk-Gardner) in SMC5 mode.

The black/white panels used as substrate here comply with the ASTM E 1347 standard and are marketed by Leneta under the name Metopac T12G panels.

It can be seen from the tables that the coatings according to the invention, with each of the interference pigments used having a silver-grey absorption colour and each of the coating process variants used, achieve good lightness and a strong lightness flop the same time as a satisfactory hiding power and are therefore capable of visually imitating metallic coatings comprising aluminium pigments in a good to very good manner. Since no metal pigments are present in the coatings, significant attenuation of radar waves by the respective coating on the substrate is not expected.

### Example 4

In order to determine the radar wave transparency, a PET film with a thickness of 350 μm (Hostaphan RN 350, Mitsubishi Polyester Film GmbH, DE) is in each case employed as substrate. The coating is carried out as pneumatic spray coating. The binder employed is the preparation WBC 000 from MIPA SE, DE.

As first layer, a fully opaque layer in the RAL shade 7037 (Dusty Grey) is applied in each case.

As the second layer, a layer with the interference pigments having a silver-grey absorption colour listed in Table 4 is in each case applied in one or four part-layers in each case and dried as described in Example 1.

Table 4 shows the dielectric constant (permittivity) of the respective layer structure and the attenuation of the radar signal in dB for a single beam passage (76.5 GHz) (instrument: RMS-D-77/79G from perisens GmbH, DE, standard mode) The uncoated PET substrate has a permittivity of about 3.2 and a radar wave attenuation of 1.05 dB.

A coating comprising a single layer on the PET substrate which comprises commercially available aluminium pigments and has a PMC of 18% by weight and a DLT of about 22 μm has, for comparison, a permittivity of about 74.9 and a one-way attenuation of the radar signal of about 4.5 dB under the same measurement conditions.

TABLE 4
Radar wave transparency

| | | | | | Attenuation |
|---|---|---|---|---|---|
| Pigment | Part- | PMC | DLT | | at 76.5 GHz |
| in layer 2 | layers | (%) | (μm) | Permittivity | (dB) |
| A | 1 | 18 | 15 | 7.3 | 1.66 |
| A | 4 | 18 | 15 | 6.6 | 1.60 |
| C | 1 | 18 | 15 | 9.8 | 1.59 |
| C | 4 | 18 | 15 | 5.8 | 1.45 |

1-13. (canceled)

14. A process for the production of a metal effect pigment-free radar-compatible coating comprising flake-form effect pigments on a substrate, said process comprising:
applying a first layer to the substrate, said first layer comprising at least one absorbent pigment and is free from flake-form effect pigments to form a coated substrate, wherein said substrate comprises a plastic plate or plastic film, and
applying a second layer to the first layer of the coated substrate, said second layer comprises flake-form effect pigments having absorbent properties is applied to the first layer in an amount of at least 10% by weight, based on the weight of the solid layer,
wherein the second layer is applied as a single layer or in two or more part-layers arranged one above the other and drying is carried out after application of each layer, and
wherein the second layer, when it is applied over the full area of a black/white background in a layer thickness of 14±2 μm and is measured spectrophotometrically in the L*,a*,b* colour space at an illumination angle of 45° and at a viewing angle of 75°, has a colour separation ΔE* between the coated black background and the coated white background of 0 to 20.

15. Process according to claim 14, wherein the second layer is applied in a total dry-layer thickness in the range from 3 to 25 μm.

16. Process according to claim 14, wherein the second layer comprises the flake-form effect pigments having absorbent properties in an amount of 10 to 40% by weight, based on the weight of the second layer.

17. Process according to claim 14, wherein that the application of the first and second layers is carried out by means of a spray process, brushing process, roller coating process, coil coating process, curtain coating processes or in-mould process.

18. Process according to claim 17, wherein the application of the second layer is carried out as a spray process in two to four part-steps by application of two to four part-layers successively and in each case on one another, where the amount of the flake-form effect pigments having absorbent properties in each of the part-layers is at least 10% by weight, based on the dry weight of the respective part-layer, and where drying is carried out at a temperature of at least 20° C. after application of each part-layer.

19. Process according to claim 18, wherein at least one of the part-layers has a dry-layer thickness of ≤5 μm.

20. Process according to claim 14, wherein that the substrate has been precoated with a primer layer.

21. Process according to claim 14, wherein a clear coat is applied to the second layer as outermost layer of the coating.

22. (canceled)

23. A vehicle part containing a substrate comprising a plastic plate or plastic film which has at least one coating produced by the process of claim 14.

24. A substrate comprising a plastic plate or plastic film which has at least one coating produced by the process of claim 14.
